(19) United States
(12) Patent Application Publication
(10) Pub. No.: US 2017/0087583 A1
(43) Pub. Date: Mar. 30, 2017

(54) Spatial Control Apparatus for Painting

(71) Applicant: Jonathan Rajala, Fowlerville, MI (US)

(72) Inventor: Jonathan Rajala, Fowlerville, MI (US)

(21) Appl. No.: 14/863,835

(22) Filed: Sep. 24, 2015

(51) Int. Cl. B05C 17/02

(52) U.S. Cl. CPC B05C 17/0245

(57) ABSTRACT

A paint roller bumper apparatus for a paint roller device having a curved rod is disclosed. The bumper apparatus includes an end cap for engaging a ceiling and a stem having the end cap on a first end a weighted bottom at a second end for keeping the bumper substantially perpendicular to the ceiling and substantially parallel to a wall. The bumper is rotationally attached to the rod using an arbor insertable into a receiving tube of a clip that can be fixedly attached to the rod.

### CROSS REFERENCE TO RELATED APPLICATIONS

This application claims the benefit of U.S. Provisional Application No. 62/156,847 filed on May 4, 2015 which is hereby incorporated herein by reference.

### TECHNICAL FIELD

This disclosure relates generally to paint rollers, and more particularly to free-rotating a bumper device for paint rollers to prevent a roller from contacting a ceiling while preventing same from bumping a wall.

### BACKGROUND

The statements in this section merely provide background information related to the present disclosure and may not constitute prior art.

Paint rollers with removable covers are well known in the art. Generally, a roller cover is installed on a roller support such that the roller cover can be removed from the roller support for discarding or cleaning after use. Paint rollers with roller frame mechanisms designed to releasably retain a roller cover on the roller support are known. Roller frames and support assemblies of this type utilize a plurality of small, resilient metal fingers that are deflected radially inward as a roller cover is installed. The metal fingers press outward against the inner surface of the roller cover, thus holding the cover in place during use. The roller cover can be removed from the support assembly by grasping it and pulling it axially off of the support assembly. Alternatively, the roller cover may be removed from the support assembly by striking roller frame on a solid object, causing the roller cover to slide off of the support assembly.

Conventional paint rollers are problematic in that no protection or guidance is offered that prevents a user from applying paint to adjacent walls or ceilings. There are a few such known paint roller bumpers developed to mitigate inadvertent painting of a ceiling, but not in the form of the present inventive apparatus

U.S. Pat. No. 5,463,789 to Zilinski discloses use of a paint roller bumper attached a fixed, upward portion of a rod of a paint roller device. This invention discloses that the fixed angle may be 30 to 45 degrees of set from the rod. The disclosure also teaches using clips, connected to the main bumper body and adapted to attach the bumper to an upward portion of a rod of a paint roller device so as to establish a fixed angle between the upper section of the main bumper body and the upward portion of the rod of preferably at least 45 degrees.

U.S. Pat. Nos. 8,332,988; and 8,615,839 to Sweeney discloses a use of a removeable bumper that can be affixed to a rod of a paint roller device so as to stop movement of the paint roller before impacting a ceiling. The bumper is attached to the rod using a mounting clamp located on the paint roller frame and configured to releasably receive and position the guide arm such that the guide arm extends past the roller cover in a fixed direction perpendicular to the longitudinal axis of the roller cover.

While the aforementioned prior art does describe bumpers for rollers, these bumpers are fixed to the rods at a particular angle and not rotatably attached to the upward section of a rod of the paint roller. Hence, the known bumpers are disadvantaged in that they obstruct use of the painting roller at particular angles on a wall as the bumper will impact the wall at certain angles. Accordingly, there is a need for a bumper that is rotatably attached allowing a user to paint a wall at varying angles while preventing the roller from striking the ceiling above.

SUMMARY

A paint roller bumper apparatus for a paint roller device having a curved rod is disclosed. The bumper apparatus includes an end cap for engaging a ceiling and a stem having the end cap on a first end a weighted bottom at a second end for keeping the bumper substantially perpendicular to the ceiling and substantially parallel to a wall. The bumper is rotationally attached to the rod using an arbor insertable into a receiving tube of a clip that can be fixedly attached to the rod.

Certain embodiments of the invention include a feature of allowing a user to refresh the paint without needing to remove the bumper.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 shows a top front perspective view of the bumper apparatus and an exemplary paint roller device, in accordance with the present disclosure;

FIG. 2 shows a bottom front perspective view of the bumper apparatus and a paint roller device, in accordance with the present disclosure;

FIG. 3 shows a front view of the bumper apparatus and a paint roller device, in accordance with the present disclosure;

FIG. 4 is a side view of the bumper apparatus and the paint roller device as seen from the right side of FIG. 3, in accordance with the present disclosure;

FIG. 5 is a top view bumper apparatus and a paint roller device, in accordance with the present disclosure;

FIGS. 6A, 6B, 7, and 8 show various views of a clip, in accordance with the present disclosure;

FIGS. 9A and 9B show the bumper apparatus without the clip, in accordance with the present disclosure;

FIG. 10 shows a series of frames illustrating the bumper apparatus in use in conjunction with a roller on a wall in various proximities to a ceiling, in accordance with the present disclosure;

FIG. 11A is a side view of the bumper apparatus, in accordance with the present disclosure;

FIG. 11B is a side view of the bumper apparatus rotated 90-degrees with respect to FIG. 11A, in accordance with the present disclosure;

FIG. 11C is a cross-sectional view of the bumper apparatus taken along line B-B of FIG. 11B, in accordance with the present disclosure;

FIG. 11D is a cross-sectional view of the bumper apparatus taken along line A-A OF FIG. 11A, in accordance with the present disclosure;

FIG. 12 is an exploded view of the bumper apparatus, in accordance with the present disclosure;

FIG. 13A is a side view of the bumper apparatus having an embodiment of the clip module, in accordance with the present disclosure;

FIG. 13B is a cross-sectional view of FIG. 13A rotated 180-degrees illustrating the embodiment of the clip module with a cap removed, in accordance with the present disclosure; and

FIG. 13C is a cross-sectional view of FIG. 13A rotated 180-degrees illustrating the embodiment of the clip module with a cap threaded on, in accordance with the present disclosure.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The word “exemplary” is used herein to mean “serving as an example, instance, or illustration.” Any aspect described herein as “exemplary” is not necessarily to be construed as exclusive, preferred or advantageous over other aspects.

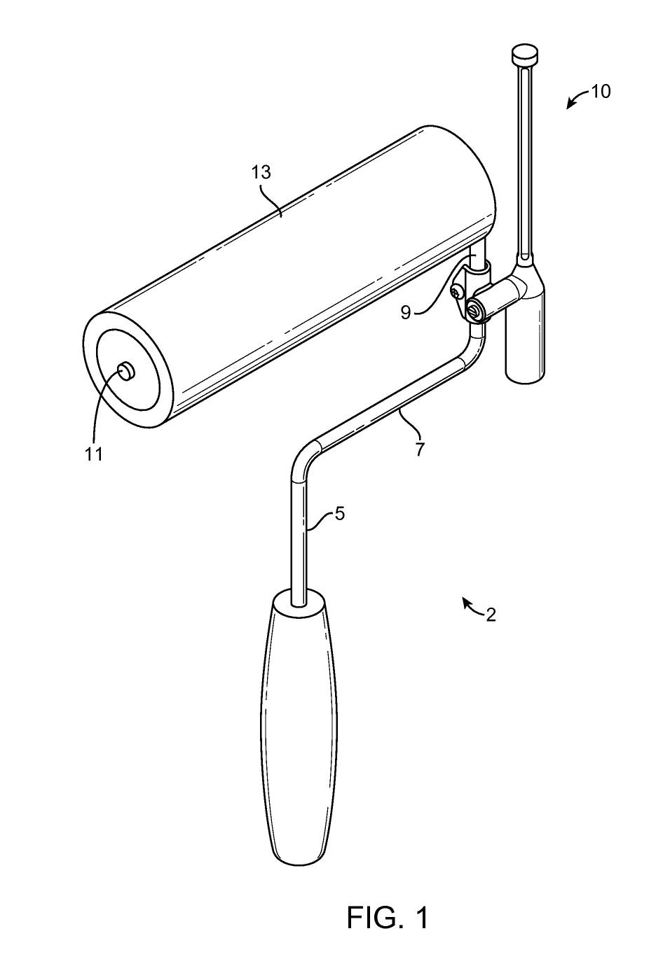

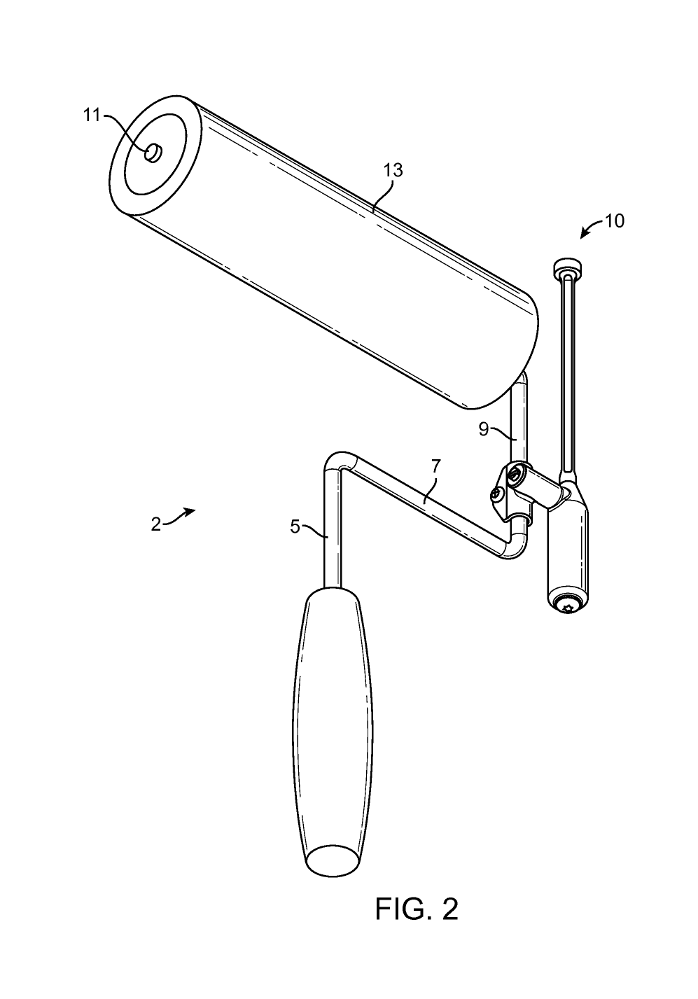

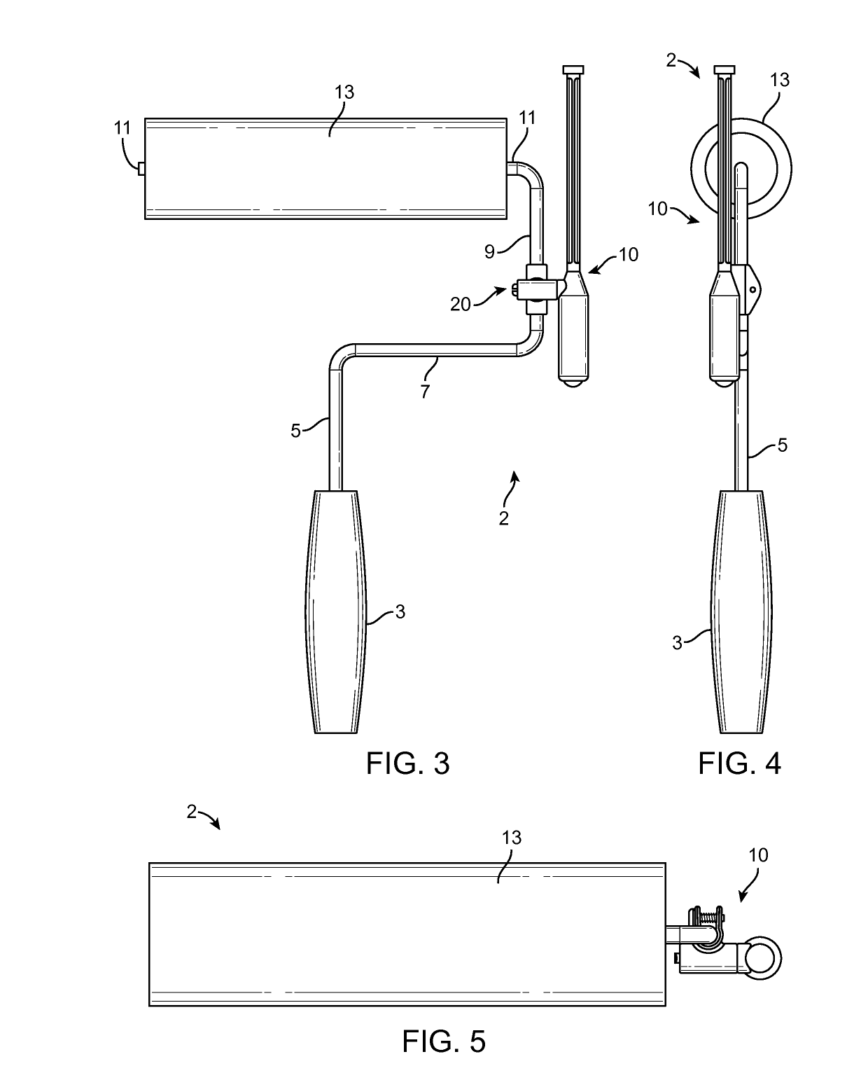

Referring now to the drawings, wherein the depictions are for the purpose of illustrating certain exemplary embodiments only and not for the purpose of limiting the same, FIGS. 1-5 show a bumper apparatus 10 for spatial control of an exemplary paint roller 2. The paint roller includes a handle 3 and a curved rod which includes a lower portion 5 which generally coaxial, traveling away from and in the same direction as the handle 3 is pointed. The curved rod further includes a middle portion 7 which generally turns at a right angle away from the lower portion 5, an upward portion 9 which generally turns at a right angle in the opposite direction away from the middle portion 7 and runs in the same plane as the lower portion 5 but aside and away from it, followed by top portion 11 which is at right angles to the upward portion 9. The top portion 11 extends through a roller 13 which may include a spindle and a hard cylinder under the nap. The bumper 10 may be formed of any suitable material including plastic, polymers or metal.

Generally, the paint roller 2 to which the bumper 10 is attached has a plastic or wooden handle 3 and extends from the handle 3 in the same direction and plane as the handle 3 itself is a rod which may be flat or circular but typically extends so as to form a series of right angles. In the exemplary roller 2, the rod extends first from the handle 3 in the same direction and plane and then to the right or left at right angles from the lower portion to form a middle portion, and then at right angles in the opposite direction to form an upward section which generally runs parallel to the ends of the roller 2, and finally is curved again at a right angle so as to itself be the main arbor or spindle receiver for a roller.

The bumper 10 can be attached to the rod at the upward portion 9. The upward portion 9 is preferably a portion of the rod which runs parallel to the end of the roller and at a right angle to the portion of the rod which contains the roller 13. (For simplicity herein, the word “roller” is used to mean the wire-spindle which is attached to the rod, as well as the cylinder as well as a nap which is attached to the cylinder in the exemplary embodiments.) The bumper 10 extends beyond a mounted roller on a paint roller 2, in embodiments without a rotational stop as described herein below. The bumper 10 is attached the curved rod preferably at the upward portion 9 via a clip module 20. The clip module 20 is removeably attached to the upward portion 9, in one embodiment.

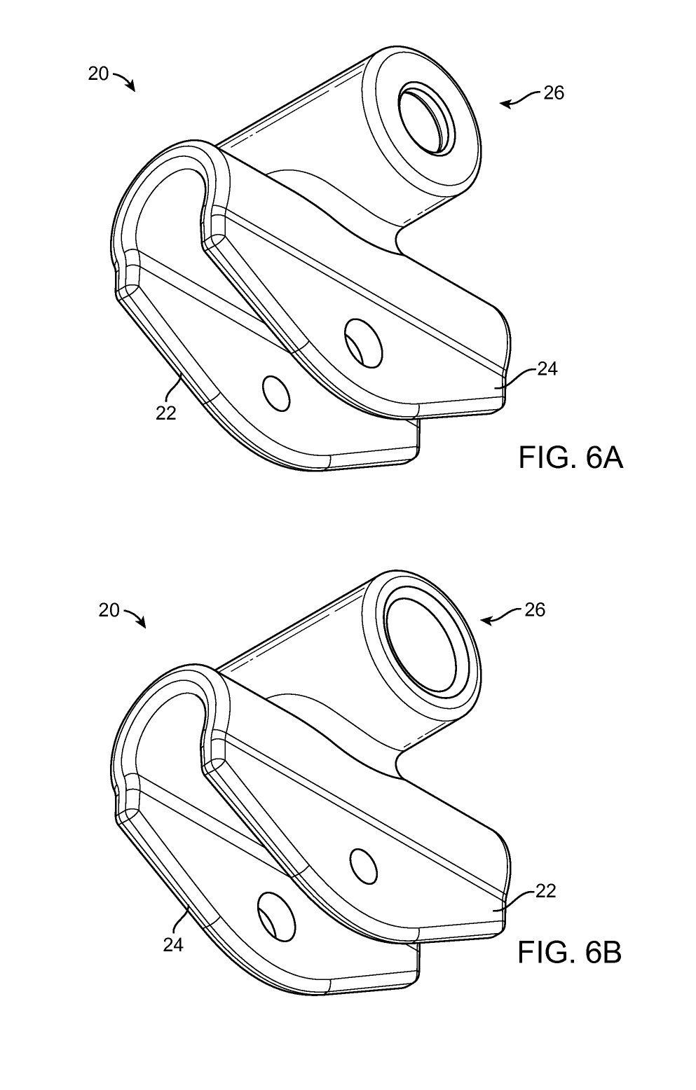

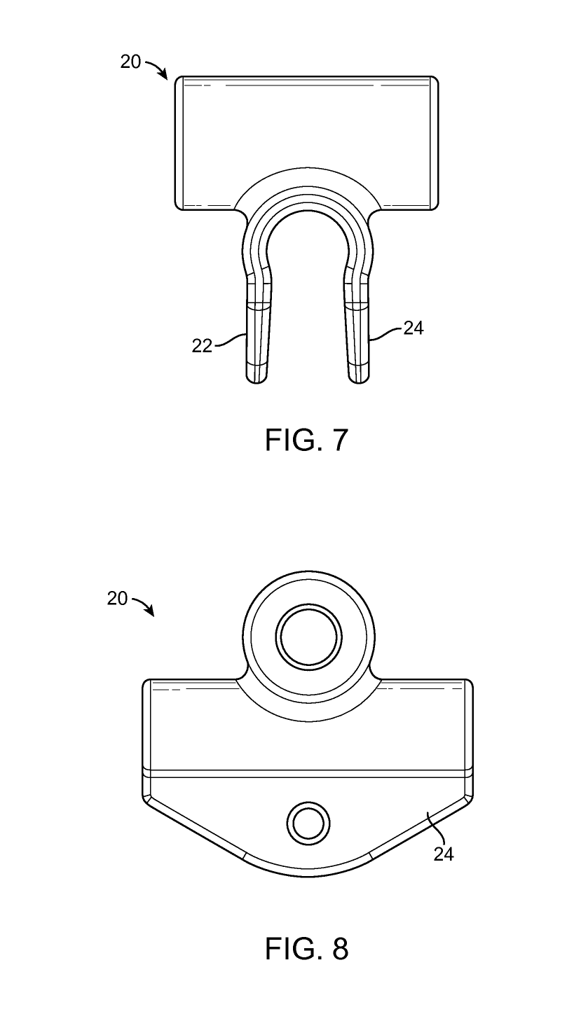

FIGS. 6A, 6B, 7, and 8 show various views of the clip module 20. As FIGS. 6A, 6B, 7, and 8 show, the clip module 20 includes a coupling members 22 and 24 for engaging the upward portion 9 of the rod. The members 22 and 24 are preferably formed of resilient material so that the members 22 and 24 are pliant for engagement of the rod at the upward portion 9. In this way, the inner surfaces of the members 22 and 24 are mated to a surface of the upward portion 9 of the rod by virtue of the material properties, the distance between the inner surfaces of the members 22 and 24, and the diameter of the rod at the upward portion 9. The clip module 20 includes a hollow cylindrical-shaped opening 26 for receiving a pin or arbor 36 of the bumper 10.

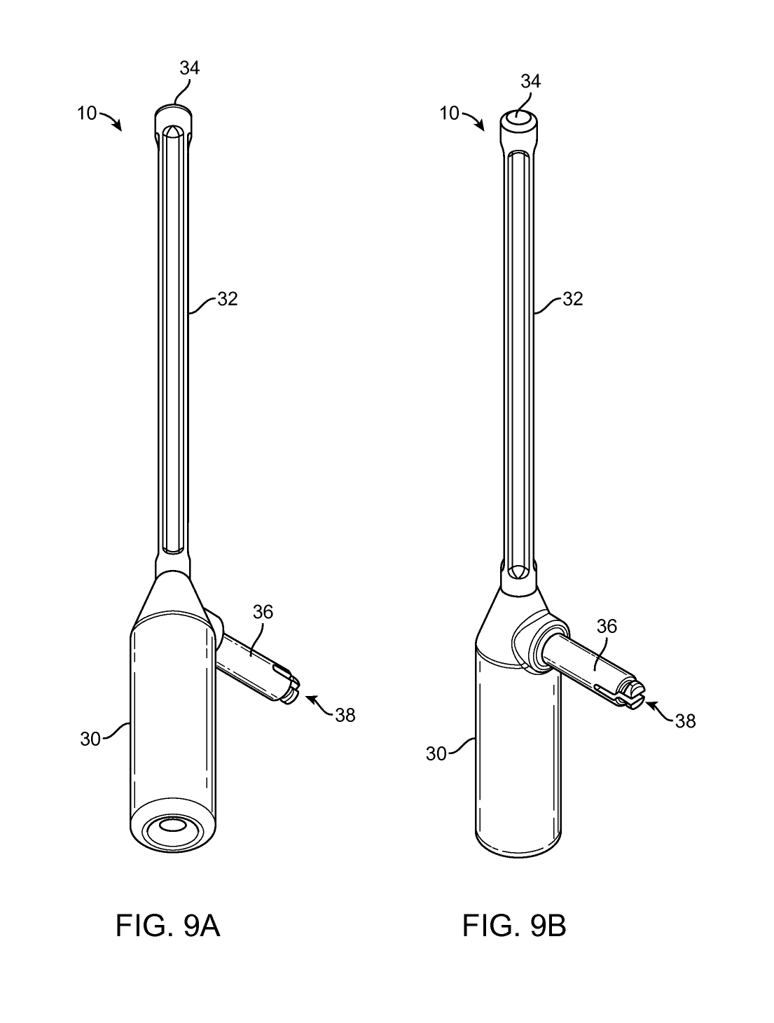

FIGS. 9A and 9B show the bumper apparatus 10 without the clip module 20. The bumper 10 includes a weighted bottom 30, a stem 32, a cap 34, and a arbor 36. The weighted bottom 30, stem 32, cap 34, and arbor 36 may be integrally formed or coupled together. In one embodiment, the cap 34, stem 32, and arbor 36 are integrally formed while the weighted bottom is coupled to the stem 32. In one embodiment, the arbor 36 includes a resilient end 38 configured to snap and hold the arbor 36 in the opening 26 of the clip module 20. The end 38 is preferably integrally formed of the arbor 36. In one embodiment, a pliability of the end 38 is derived from a space 39 cut into an end portion of the arbor 36. In one embodiment, the end 38 has a diameter greater than the diameter of the arbor 36.

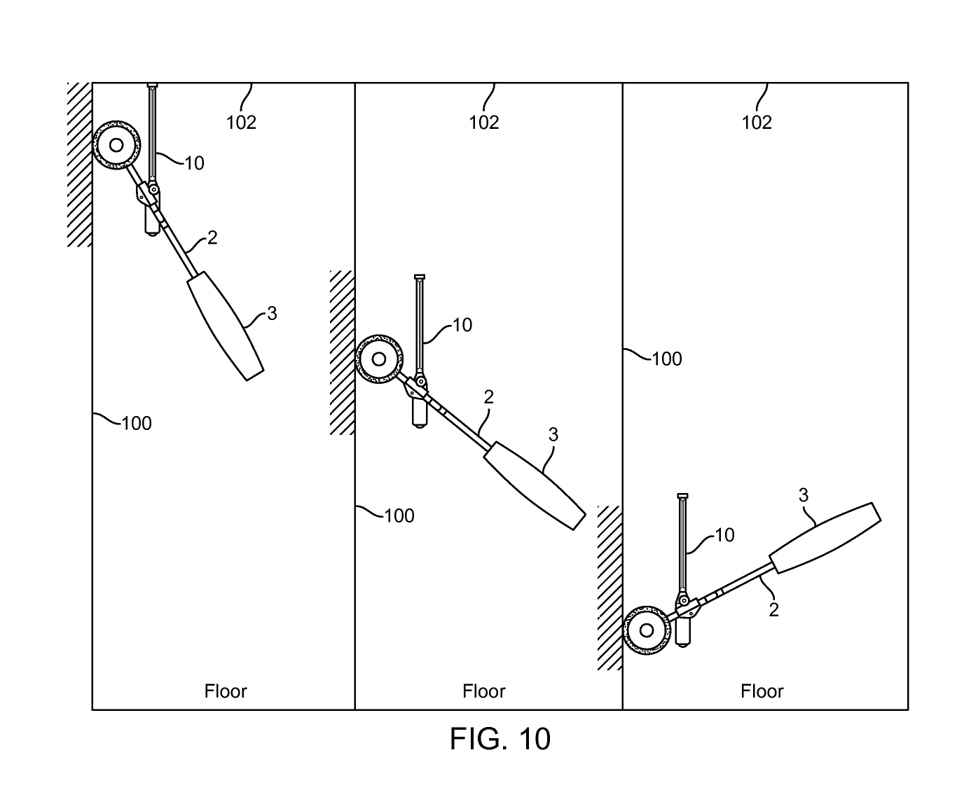

FIGS. 10A, 10B, and 10C show the bumper apparatus 10 in use in conjunction with a roller 2 on a wall 100 in various proximities to a ceiling 102 to illustrate the rotating property of the bumper 10. As FIGS. 10A, 10B, and 10C show, the bumper apparatus 10 rotates independently of the roller 2 and the rod it is attached to. In this way, the apparatus 10 remains positioned to stop the roller from impacting the ceiling 102 while remaining away from the wall 100. In operation, a user can utilize a roller from a bottom portion of the wall 100 to the ceiling 102.

FIG. 10A shows a side view of the roller 2 and bumper in proximity to a ceiling 102. The roller 2 is being applied against the wall 100, applying paint. The paint roller 2 is at its near upper most possible position as the bumper 10 has almost come into contact with the ceiling 102, preventing the roller 2 from contacting the ceiling 102 and thereby preventing any paint on the roller 2 from touching the ceiling 102.

FIG. 10B shows the paint roller 2 applied in a mid-position along the wall 100. As FIG. 10B shows, the bumper 10 has rotated with the change in angle of the rod and the handle 3, thereby remaining away from a surface of the wall 100. FIG. 10C shows the paint roller 2 applied in a bottom position along the wall 100. As FIG. 10C shows, the bumper 10 has continued to rotation with the change in angle of the rod and the handle 3, thereby remaining away from a surface of the wall 100.

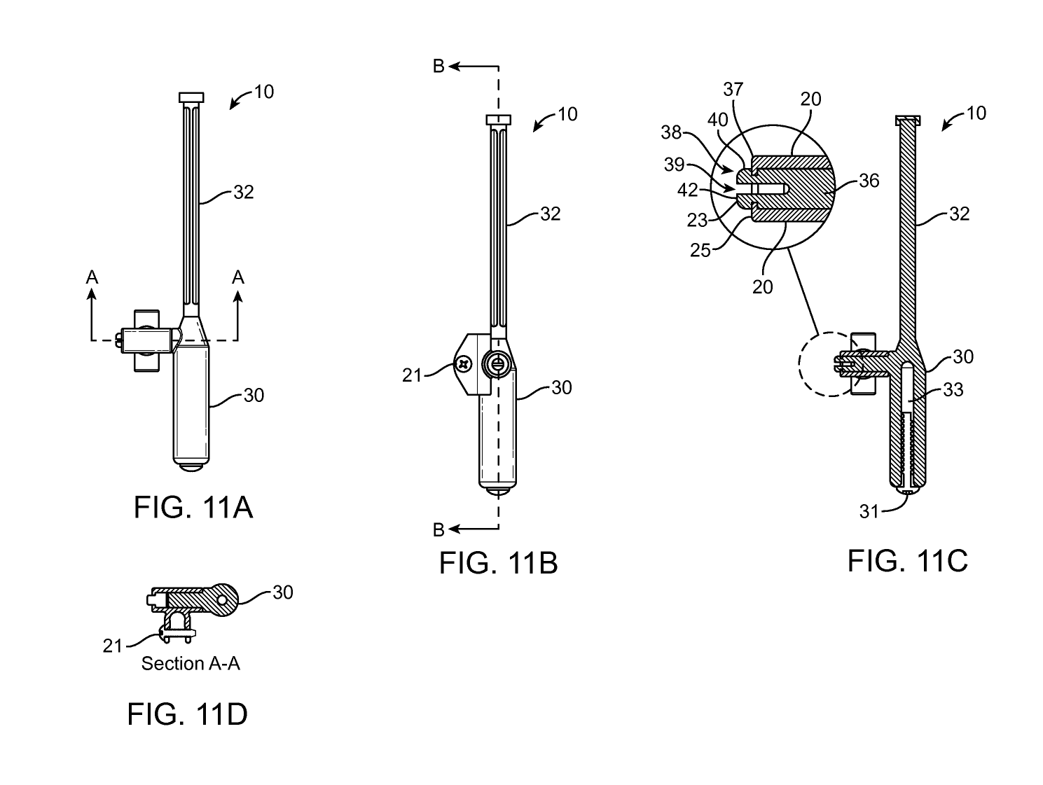

FIGS. 11A and 11B are side views of the bumper apparatus 10. FIG. 11B is a side view of the bumper apparatus 10 or FIG. 11A, rotated 90-degrees along a horizontal axis. FIG. 11C is a cross-sectional view of the bumper apparatus 10 taken along line B-B of FIG. 11B. As FIG. 11C shows, the resilient end 38 of the arbor 36 is positioned within the clip module 20. An end 21 of the clip module 20 includes an axially protruding stop 23 defined by the radial surfaces thereof. The stop 23 preferably protrudes so as to engage an axial recessed portion 37 of the arbor 36 so as to be flush with an interior surface thereof. The end 38 of the arbor 36 includes a top portion 40 and a bottom portion 42 separated by the space 39. The top portion 40 and the bottom portion 42 have a rounded end. In one embodiment, the rounded end aids insertion of the arbor 36 passed the stop 23, engaging the stop 23 with the recessed portion 37 thereby holding the arbor 36 rotatably within the clip module 20. FIG. 11C further shows a mechanical fastener 31 inserted within a cavity 33 of the weighted bottom 30. The mechanical fastener 31 is included to add weight to the bottom portion 30. In one embodiment the weighted bottom 30 is formed of additional material comparted with a top portion of the stem 32 such that gravity aligns stem 32 vertically whereat the weighted bottom 30 is located in a bottom position.

FIG. 11D is a cross-sectional view of the bumper apparatus taken along line A-A. As FIG. 11D shows, a mechanical fastener 21 may be used to tighten the clip module 20 to a rod of a paint roller 2.

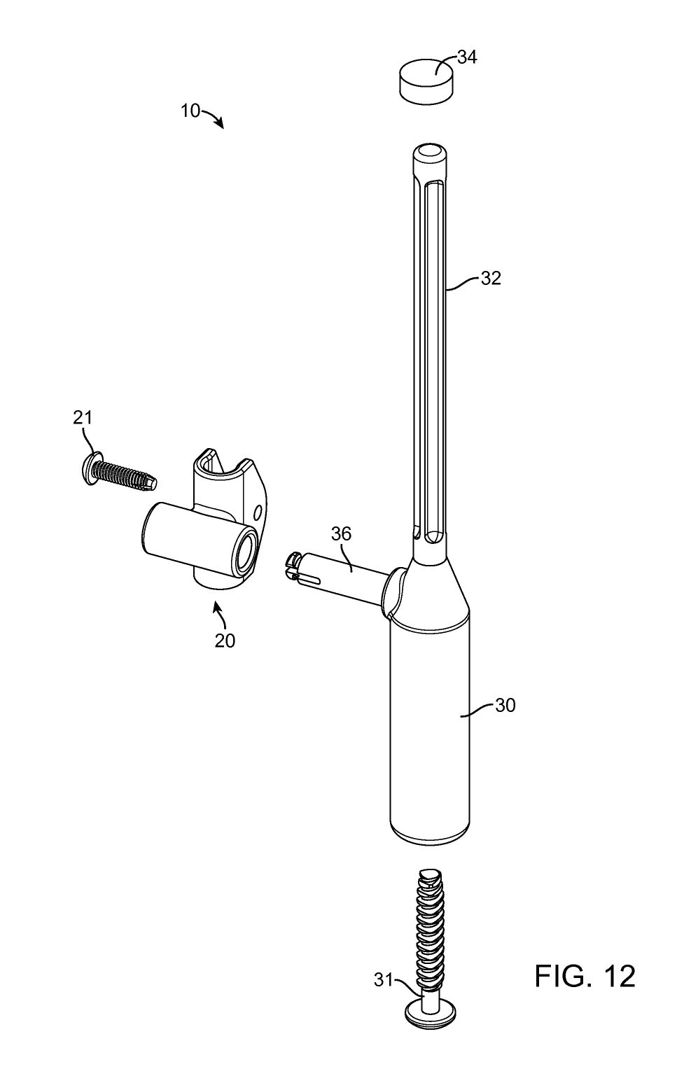

FIG. 12 is an exploded view of the bumper apparatus 10. As FIG. 12 further shows, the bumper apparatus 10 may be comprised of a main, integral portion having a stem 32 and a bottom portion 30 having a weighted insert such as the mechanical fastener 31 to which a cap 34 may be affixed or secured thereto. The bumper apparatus 10 further includes the clip module 20 rotatably securable over the arbor 36. As described herein above, in various embodiments the mechanical fastener 21 may then be threaded or inserted through the clip module 20 for securing of the bumper apparatus 10 to the rod of the paint roller 2.

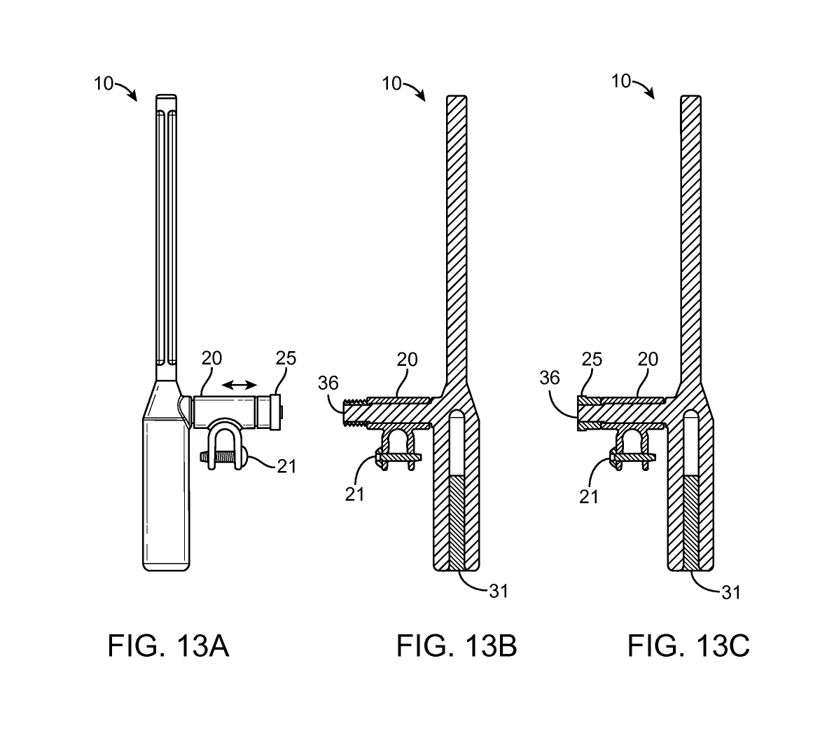

FIG. 13A-13C illustrate the bumper apparatus 10 having an alternative embodiment of the clip module 20 that may be slid on the arbor 36 so that the clip module 20 may freely rotate around the arbor 36. A cap 25 may be threaded onto the arbor 36 so that the clip module 20 may be held onto the arbor 36. In one embodiment, the cap 25 may be used to hold the clip module 20 in a particular place, i.e., limit or stop the free rotation of the clip module 20. Removal of the cap 25 allows easy removal of the clip module 20 from the arbor 36. In use, one may simply remove the cap 25 from the arbor 36 to free the clip module 20, and thereby the bumper apparatus 10 from any connecting rod of a paint roller.

The disclosure has described certain preferred embodiments and modifications thereto. Further modifications and alterations may occur to others upon reading and understanding the specification. Therefore, it is intended that the disclosure not be limited to the particular embodiment(s) disclosed for carrying out this disclosure, but that the disclosure will include all embodiments falling within the scope of the appended claims.

1. A paint roller bumper apparatus for a paint roller device having a curved rod, the bumper comprising:
an end cap;
a stem having the end cap on a first end and having an arbor, wherein the arbor is disposed substantially perpendicular to the stem;
a clip module having a receiving tube for the arbor; and
a weighted bottom at a second end of the stem.

2. The paint roller bumper apparatus of claim 1, wherein the weighted bottom is formed of a different material than the stem.

3. The paint roller bumper apparatus of claim 1, wherein the end cap is formed of a different material than the stem.

4. The paint roller bumper apparatus of claim 1, wherein the clip module comprises two resilient members shaped to engage the rod.

5. The paint roller bumper apparatus of claim 4, wherein the resilient members each include an opening for receiving a mechanical fastener.

6. The paint roller bumper apparatus of claim 1, wherein the arbor includes a centrally positioned void space.

7. The paint roller bumper apparatus of claim 1, wherein the arbor includes an end having a greater diameter than a middle portion.

8. The paint roller bumper apparatus of claim 1, wherein the arbor comprises two resilient rounded members each having an end with a protruding member above the axial surface.

9. A paint roller bumper apparatus for a paint roller device having a curved rod, the bumper comprising:
an end cap;
a stem having the end cap on a first end and having an arbor, wherein the arbor is disposed substantially perpendicular to the stem;
a clip module having a cylindrical tube for receiving the arbor and members for fixedly engaging the rod; and
a weighted bottom at a second end of the stem.

10. The paint roller bumper apparatus of claim 9, wherein the weighted bottom is formed of a different material than the stem.

11. The paint roller bumper apparatus of claim 9, wherein the end cap is formed of a different material than the stem.

12. The paint roller bumper apparatus of claim 9, wherein the clip module comprises two resilient members shaped to engage the rod.

13. The paint roller bumper apparatus of claim 12, wherein the resilient members each include an opening for receiving a mechanical fastener.

14. The paint roller bumper apparatus of claim 9, wherein the arbor includes a centrally positioned void space.

15. The paint roller bumper apparatus of claim 9, wherein the arbor includes an end having a greater diameter than a middle portion.

16. The paint roller bumper apparatus of claim 9, wherein the arbor comprises two resilient rounded members each having an end with a protruding member above the axial surface.

17. A paint roller bumper apparatus for a paint roller device having a rod, the bumper comprising:
an end cap configured to engage a ceiling;
a stem having the end cap on a first end and having an arbor, wherein the arbor is disposed substantially perpendicular to the stem;
a clip module having a hollow cylindrical tube for receiving the arbor and a clip portion for securing to the rod of the paint roller device, wherein the arbor comprises an end having threads and a smooth portion for rotatably engaging an interior of the clip module;
a second cap for threadably engaging the arbor to hold the clip onto the arbor; and
a mechanical fastener engaged to the stem within the cavity.

18. The paint roller bumper apparatus of claim 17, wherein the cavity is an annular-shaped, elongated void.

19. The paint roller bumper apparatus of claim 18, wherein the second cap may be threadably engaged to limit rotation of the clip about the arbor.

20. The paint roller bumper apparatus of claim 19, wherein the second cap may be selectively removed for disengagement of the clip module from the arbor.
